(19) United States
(12) Patent Application Publication
(10) Pub. No.: US 2003/0061148 A1
(43) Pub. Date: Mar. 27, 2003

(54) Financial derivative and derivative exchange with guaranteed settlement

(76) Inventor: Shahram Alavian, North York (CA)

Correspondence Address: GORDON THOMSON, 1353 MOUNTAINSIDE CRES, OTTAWA, ON, K1E3G5, CA

(21) Appl. No.: 10/195,404

(22) Filed: Jul. 16, 2002

Related U.S. Application Data
(60) Provisional application No. 60/305,076, filed on Jul. 16, 2001.

(51) Int. Cl. G06F 17/60

(52) U.S. Cl. 705/37

(57) ABSTRACT

A financial derivative exchange with guaranteed settlement comprising: an electronic trading forum wherein derivatives are actively traded between market makers and investors; means for investors to open and close positions in the electronic trading forum; means for market makers to open and close positions in the electronic trading forum; means for guaranteed settlement of positions thereby reducing the risk of default of the investor or market maker; and, means for inputting market information into the electronic trading forum so that the values of underlying securities are accurate. Also provided is a method for trading financial derivatives over an exchange having guaranteed settlement comprising: providing an electronic trading forum wherein derivatives are actively traded between market makers and investors; providing means for investors to open and close positions in the electronic trading forum; providing means for market makers to open and close positions in the electronic trading forum; providing means for guaranteed settlement of positions thereby reducing the risk of default of the investor or market maker; and, providing means for inputting market information into the electronic trading forum so that the values of the underlying securities and commodities are accurately reflected in the value of the derivatives.

### CROSS REFERENCES TO RELATED APPLICATIONS

This application is entitled to the benefit of Provisional Patent Application Serial No. 60/305,076 filed on Jul. 16, 2001.

### FIELD OF THE INVENTION

The present invention relates to the trading of securities and commodities within an organized system and more particularly relates to trading financial derivatives in an over the counter market having guaranteed settlement features.

### BACKGROUND OF THE INVENTION

Trading financial derivatives is well known. Generally, a derivative is a financial instrument in the form of a contract that is derived from securities or physical markets. A financial derivative is a risk management tool used to hedge the risk of owning things that are subject to unexpected price fluctuations, such as, foreign currencies, bushels of wheat, stocks and government bonds. Derivatives can also be used to speculate on the movement of commodity or security prices, interest rates or the levels of financial indices. There are many types of financial derivatives. However, two of the most commonly traded derivatives are options and futures contracts. Future contracts pertain to the future delivery of a commodity at a specified price. An option gives one party the right to buy from or sell to another party at a prearranged price. The value of a financial derivative is derived, at least in part, upon the value of a related asset or liability. Therefore, financial derivatives are financial securities whose value is derived from another “underlying” financial security. Options, futures, swaps, swaptions, structured notes are all examples of derivative securities. The valuation of derivatives makes use of the statistical mathematics of uncertainty, which is very complex. Some derivatives are compared to insurance. Just as you pay an insurance company a premium in order to obtain some protection against a specific event, there are derivative products that have a payoff contingent upon the occurrence of some event for which you must pay a premium in advance. When one buys a cash instrument, for example 100 shares of ABC Inc., the payoff is linear (disregarding the impact of dividends). If we buy the shares at $50 and the price appreciates to $75, we have made $2500 on a mark-to-market basis. If we buy the shares at $50 and the price depreciates to $25, we have lost $2500 on a mark-to-market basis. A derivative works as follows. Instead of buying the shares in the cash market, we could have bought a 1-month call option on ABC stock with a strike price of $50, giving us the right but not the obligation to purchase ABC stock at $50 in 1 month's time. Instead of immediately paying $5000 and receiving the stock, we might pay $700 today for this right. If ABC goes to $75 in 1 month's time, we can exercise the option, buy the stock at the strike price and sell the stock in the open market, locking in a net profit of $1800. If the ABC stock price goes to $25, we have only lost the premium of $700. If ABC trades as high as $100 after we have bought the option but before it expires, we can sell the option in the market for a price of $5300. The option in this case gives us a great deal of positional flexibility with a different risk/reward profile.

As with any other type of investment, trading derivatives over an open exchange system has inherent risks. One of these risks and therefore an important feature of a derivative exchange relates to the integrity of the settlement. In other words, when a particular trading position is closed, one party delivers the underlying commodity or its equivalent in cash, to another party, in full. Exchange policies established by the supervisory exchange commission help to ensure the fair and safe operation of the derivative exchange. However, one problem relates to the fact that one trading individual may be exposed to an unlimited risk and significant loss. In some situations, a party may have a position that is in a loss to such an extent that payment is impossible. This leads to instability in the exchange and undermines public confidence in the exchange. There have been a number of publicized corporate bankruptcies related to derivatives trading. Therefore it is a desired feature of a derivative exchange to minimize defaults to the greatest extent possible.

A number of methods and solutions have been proposed to reduce the risk associated with trading derivatives and increase public confidence in the use of such instruments. Some examples can be found in U.S. Pat. No. 4,903,201 “Automated Futures Trading Exchange” (1990); U.S. Pat. No. 5,963,923 “System and Method for trading having a Principal Market Maker” (1999); and, U.S. Pat. No. 6,195,647 “On-line Transaction Processing System For Security Trading” (2001). While these patents seek to reduce inherent efficiencies in exchange systems in order to speed up the trading process they do not address the problem of settlement integrity. Therefore there continues to be a need for a financial derivative and derivative exchange having a high degree of settlement integrity to prevent unreasonable losses and maintain public confidence.

### OBJECTS OF THE INVENTION

It is an object of the present invention to overcome the deficiencies in the prior art noted above.

Another object of the invention is to provide a financial derivative and derivative exchange having a high degree of settlement integrity to prevent unreasonable losses and maintain public confidence.

Another object of the present invention to provide a financial derivative and derivative exchange with guaranteed settlement regardless of the level of volatility in underlying commodity's market and financial strength of the market makers or any of the traders after initiating the position.

Still another object of this invention is to provide a financial derivative and derivative exchange that predetermines the maximum cash settlement and collects that amount at the time of order initiation and then settles the accounts without the involvement of either the trader or the market maker.

Further objects and advantages of the invention will become apparent from a consideration of the following, summary, drawings and detailed description.

### SUMMARY OF THE INVENTION

In accordance with the present invention there is provided a financial derivative exchange with guaranteed settlement comprising: an electronic trading forum wherein derivatives are actively traded between market makers and investors; means for investors to open and close positions in the electronic trading forum; means for market makers to open and close positions in the electronic trading forum; means for guaranteed settlement of positions thereby reducing the risk of default of the investor or market maker; and, means for inputting market information into the electronic trading forum so that the values of underlying securities are accurate.

There is also provided in this invention a method for trading financial derivatives over an exchange having guaranteed settlement comprising: providing an electronic trading forum wherein derivatives are actively traded between market makers and investors; providing means for investors to open and close positions in the electronic trading forum; providing means for market makers to open and close positions in the electronic trading forum; providing means for guaranteed settlement of positions thereby reducing the risk of default of the investor or market maker; and, providing means for inputting market information into the electronic trading forum so that the values of the underlying securities and commodities are accurately reflected in the value of the derivatives.

In another embodiment of the invention the electronic trading forum is a computer suitably programmed to execute derivative trading and remotely accessible by investors and market makers.

In yet another embodiment of the invention a server is operably connected to the computer for receiving instructions from remote investors and market makers and relaying them to the computer and for transmitting trading confirmations from the computer to the investor and market maker. The server stores data files containing relevant information with respect to the accounts of the investor and market maker.

In one embodiment of the invention the investor and the market maker have access to the server through a remote terminal whereby instructions to open and close positions can be relayed through the server to the computer and further whereby the investor's account information and market prices can be displayed. Access can also be through the Internet or by wireless devices adapted to send and receive trading instructions.

In still another embodiment of the invention there is provided means for guaranteed settlement of positions comprising: an investors electronic account containing investment funds accessible by the computer; a market-marker's electronic deposit account containing investment funds accessible by the computer; an electronic exchange account to which funds sufficient to cover a position is automatically transferred from the investor's account and the market maker's account when their respective positions are opened and from which funds are dispensed to the investor and market maker when the position is closed and the payout routine is executed; and, means for determining payout of a position. In this manner, the trader deposits the total sum of money required to cover the position in the exchange deposit account as soon as the investor places an order to open a position. The market maker is also required to deposit sufficient funds into the exchange deposit account once the investor's order matches the market maker's bid price.

In another embodiment of the invention there is provided an investor account verification routine executed by the server after every trade request by the investor that comprises: accepting the investor's request to open a trading position; calculating the amount of funds necessary to settle the trading position; verifying that sufficient funds are available in the investor's electronic trading account; if sufficient funds are available, transferring the funds from the investor's electronic investment account to the exchange deposit account; notify the investor of the transfer of funds; update the trading board to reflect the investor's position; display the trading board to the investor.

The invention also includes a process whereby the investor can open a short or long position in the exchange by: inputting the required data into the exchange server indicative of a long or short position; the exchange server confirms that the trading order is for a long or short position; the exchange server determines if the investor's bid price is at the market price; the exchange server transmits the required funds from the investor's account to the exchange deposit account; if the investor's bid price is at the market price the server transmits the order to the exchange for execution; the exchange confirms execution of the order to the server; the server confirms execution of the order to the investor; the exchange server takes the record off of the trading board; and, the server creates a new long or short position for the trader.

In another embodiment of the invention there is provided a process for closing a position comprising: the investor indicating to the exchange server the desire to close a trading position or alternatively the position time expires; the server relays the instructions to the exchange; the exchange executes a payoff routine to determine the amount of funds due to the market maker or the investor; the exchange transfers the required funds from the exchange deposit account to the investor's and market maker's accounts as required. Therefore, once the payoff is calculated the exchange will deposit funds back to both the investor and the market maker equal to their respective payoff amounts.

My invention has the following advantages:

The total possible loss and/or gain is equal to the amount on deposit in the exchange deposit account;

There is no premium required on the derivative because they are initiated with a deposit from the investor and the market maker;

Positions are not bought or sold;

Positions are settled between the investor and the market maker by cash after the position is closed; and,

The position is opened at the choice of the investor after the investor has had the opportunity to consider the asking price of the market maker and the position is closed at the spot value.

### BRIEF DESCRIPTION OF THE DRAWINGS

FIG. 1 is a diagram representation of the proposed exchange of the preferred embodiment of the invention.

FIG. 2 is a flow chart showing the process for verifying the funds in the investor's account by the exchange server.

FIG. 3 is a representation of the exchange network.

FIG. 4 is a representation of the exchange process.

FIG. 5 is a flow chart showing the process of opening a long or short position by the investor in the exchange.

FIG. 6 is a flow chart showing the closure of a position and the transfer of funds from the exchange deposit account.

FIG. 7 is a graph comparing the derivative of the present invention to other investments.

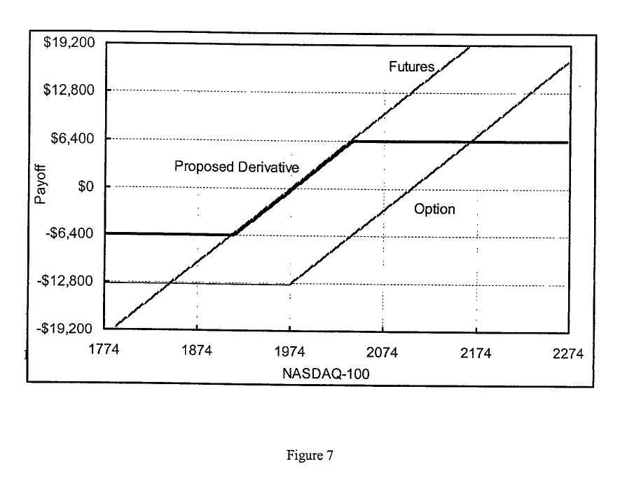

### DETAILED DESCRIPTION

The Derivative

The derivative can be described by the following mathematical expression.

$$P ( t ) = \{ \begin{matrix} D & if D < ϵ d [ S ( t ) - {v}_{ϵ} ( 0 ) ] \\ ϵ d [ S ( t ) - {v}_{ϵ} ( 0 ) ] & if - D < ϵ d [ S ( t ) - {v}_{ϵ} ( 0 ) ] < D \\ - D & if - D > ϵ d [ S ( t ) - {v}_{ϵ} ( 0 ) ]\end{matrix} \\ where$$

P is the payoff excluding supplementary charges like trading charges.

d is dollar-per-unit-value (DUV).

D is the total deposit

v(0) is the value at which the position is opened.

S(t) is the spot value at time t.

ε=“−” for short, and “+” for long positions.

t=time, which ranges from the initiation of the position, 0, to its maturity, T.

The total possible loss and total possible gain are equal to the deposit (D). There is no premium required on the derivative. The derivative is not purchased but initiated with a deposit from both the trader and the market maker. The position is opened with the choice of the trader after considering the bid provided by the market maker and it is settled at the spot value.

The payoff for such a derivatives may be replicated by employing trading strategies involving options such as bull and call spreads. In summary, one can create a similar payoff by taking a long and short positions on the options, of same maturity and underlying, at different strike prices. However, there are fundamental differences. The composite spread needs to be purchased while the derivative proposed here requires a deposit. One consequence of this difference is the interest earned on the deposit over the life of the contract. One more difference to mention is that both legs of the option spread need to be created at almost the same time before the change in bid-ask prices because the net price of position unfavorable. While on the other hand, the derivative described here is already a unit position, which can be created by a single trade. Another difference is the risk exposure for the market maker. Both legs of the position may not, and usually are not, taken against a single counter-party. This means that, though the holder of the spread position has “capped” the risk, the same is not true for the counter-party who has a long or a short position on a single option leg of the spread. Meanwhile, since the derivative proposed here is inherently a single unit position, both counter-parties take advantage of the limited risk exposure.

The trader deposits the total deposit with the exchange at the time the order to open a position is placed. The exchange also deposits with its account the total deposit from the market maker's account once the trader's order matches the market maker's bid. At the time the position is being closed, the payoff is calculated and the exchange deposits back the cash to both the trader and the market maker's account, equal to the payoff amounts.

The Exchange

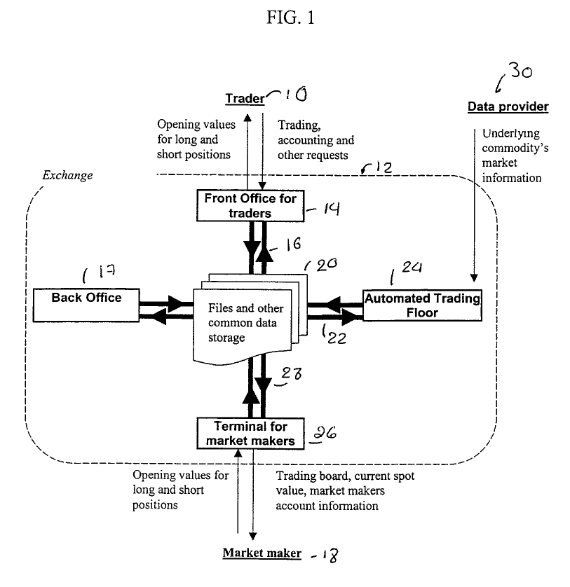

Referring to FIG. 1 there is shown a derivative exchange in a preferred embodiment of the invention. The trader (10) desires to open a position for a derivative on the derivative exchange (12). The trader is provided access to the exchange (12) through a virtual front office (14). The virtual front office (14) is a computer terminal electronically linked (16) to the exchange through a communications network such as the Internet. Therefore, access to the virtual front office can be accomplished remotely from the trader's home or office. A back office (17) is included for closing the positions at maturity and producing the historical information regarding, market maker's, broker's and exchange's transactions, periodical statements and other regulatory reports.

Wireless communications through a personal computing device or mobile telephone is also contemplated by this invention. Within the environment of the virtual front office the trader is able to obtain opening values for the long and short positions of particular securities set by the market maker (18). Additionally, administrative information with respect to trading accounts personal information is also available at the virtual office. A new trader may open an account through the virtual office. The trader executes trades through the virtual office.

Still referring to FIG. 1, the virtual front office is connected to a common server (20). The server stores the administrative account files of the trader and market maker. The server also routes trading instructions (22) from the trader and market maker to the automated virtual trading floor (24). The server also contains routines for investor registration, and investor login, challenge-response, and, investor account verification. The investor registration routine comprises the following steps:

a. investor accessing the exchange server through a remote terminal;

b. investor indicating a desire to register with the exchange;

c. exchange server requesting registration information from the investor comprising:

i. personal identification data; and,

ii. financial information;

d. investor executing a contract agreeing to terms and conditions of exchange use;

c. server issuing registered investor with a password to be used;

The login routine comprises the following steps:

a. the investor accessing the exchange server through a remote terminal;

b. the exchange server demanding the investor's identification data;

c. the investor provides the exchange server with identification data; and,

d. the exchange server confirms identity of registered investor.

The response-challenge routine occurs after the exchange server confirms the identity of the registered user and comprises the following steps:

a. the exchange server issuing a challenge to the investor by demanding the registered pass word;

b. the registered investor providing the registered password to the exchange server;

c. the exchange server verifying the correct password; and,

d. the exchange server permits the investor access to the derivative exchange.

The investor account verification routine is executed by the server after every trade request by the investor and comprises the following steps:

a. accepting the investor's request to open a trading position;

b. calculating the amount of funds necessary to settle the trading position;

c. verifying that sufficient funds are available in the investor's electronic trading account;

d. if sufficient funds are available, transferring the funds from the investor's electronic investment account to the exchange deposit account;

e. notify the investor of the transfer of funds;

f. update the trading board to reflect the investor's position;

g. display the trading board to the investor.

The market maker also has access to a computer terminal (26) in which the market maker can post the opening values for long and short positions for particular securities. The market maker maintains a trading board and the current spot value of a given security through the terminal (26). The market maker terminal (26) is electronically linked (28) to central server (20). Central server (20) stores administrative files of the market maker and transmits order information from the market maker to the virtual trading floor (24).

The virtual automated trading floor (24) is configured to receive data from a data provider (30) regarding market information affecting the value of the commodity underlying the derivative being traded. The trading floor is a central processing unit having software adapted to execute orders according to the derivative algorithm defined above.

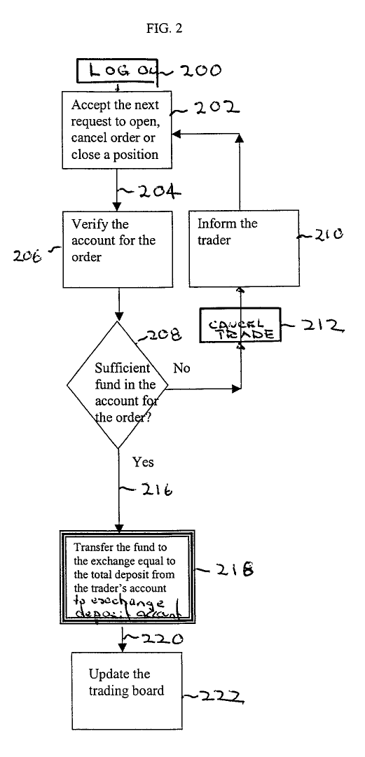

One important element of the invention to ensure settlement integrity is assurance that the trader has sufficient funds in an account to cover the trade. Referring to FIG. 2, the present invention includes a verification routine nested within the server and initiated when the trader seeks to trade through the front office. The trader accesses the virtual front office through a terminal by a log-on protocol (200). The trader enters instructions through the virtual office to place an order, cancel an order or close a position (202). The server receives the instructions from the virtual front office (204). The server verifies the identification of the account holder provided during the log-on protocol (206). The server then verifies that there are sufficient funds available in the trader's account to cover the requested transaction (208). If there are not sufficient funds within the trader's account, the trader is notified (210) and the trade is cancelled (212). The trader then has the opportunity to transfer funds into the account by electronic or other means. When the server verifies that there are sufficient funds in the trader's account to cover the transaction (216) the server will transfer the all necessary funds to cover the transaction from the trader's account to an exchange deposit account (218). The money is held at the deposit account until the trader's position is closed. The server then notifies (220) the market maker of the trader's desired transaction and the market board is updated to reflect the trader's position (222).

The Exchange Network

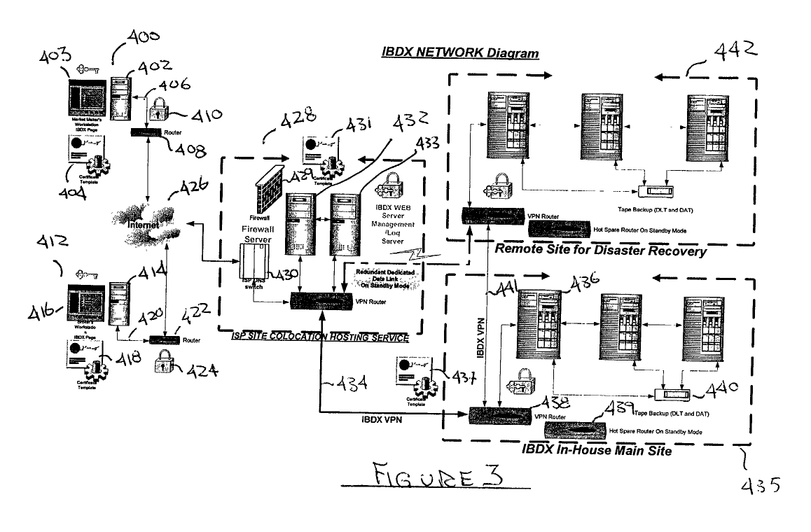

Referring now to FIG. 3, there is shown the derivative exchange network of one embodiment of my invention. The market maker's workstation (400) comprises a computer station (402) having a log-in protocol (403) for the market maker to access the exchange. The computer station is certified (404) has having authority to access the exchange to prevent unauthorized entry. Computer station (402) is operatively connected (406) to router (408). Between the computer station and router there is a security provision (410) that will prevent access to the router in the event that the market maker's identity is not confirmed during the log-in process. In this manner a virtual private network is created between the market maker and the Internet. Once the market maker is log-in the router will connect to the Internet (426).

The derivative trader, in this example shown as an authorized broker receiving and executing instructions from clients, also has a computer workstation that is operatively connected through the Internet to the exchange. The broker's workstation (412) comprises a computer station (414) having a log-in protocol (416) for broker to access the exchange. The computer station is certified (418) has having authority to access the exchange to prevent unauthorized entry. In this way a virtual private network is created between the broker and the Internet. Computer station (414) is operatively connected (420) to router (422). Between the computer station and router there is a security provision (424) that will prevent access to the router in the event that the market maker's identity is not confirmed during the log-in process. Once the market maker is log-in the router will connect to the Internet (426).

Access to the exchange will be coordinated through an Internet Service Provider (ISP) (428) hosting service that may be co-located with the broker, the market maker or the exchange. The ISP comprises a firewall (429) comprising a firewall server (430). The firewall server will be certified (431) as part of the exchange network and upon being challenged by either the broker or market maker workstation will confirm that it is authorized to moderate instructions to and from the exchange. The ISP host will further comprise an exchange web site server (432) to provide a virtual office to the exchange and a management/log server (433) to moderate traffic to and from the exchange. The ISP host router will be operatively connected (434) to the exchange (435).

The exchange (435) comprises adequate computational ability (436) to receive and process data received from brokers, market makers and the market in order to make the exchange operate in real-time. The exchange will be certified (437) and able to challenge and respond to challenges to and from the ISP host. In this way a virtual private network is created between the ISP host and the Internet as well as between the ISP and the exchange. The exchange further comprises an active secure virtual private network router (438) as well as a standby router (439) able to engage automatically upon failure of the active router. Add data transactions are stored on a reliable data storage device, (440) for example, a DLT and DAT. The router is also in continual communication (441) with a remote site for disaster recovery (442) that has the same components and operability as the exchange. In this way the exchange will operate with high reliability.

General Process Flow Within the Exchange

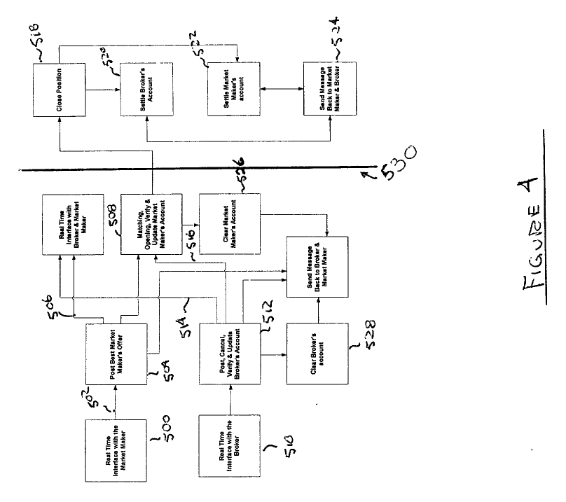

Referring to FIG. 4, there is shown a diagram representing the general flow of information within the exchange for processing and executing derivative exchange instructions. The real-time interface between the exchange and market maker is represented by block (500). The market maker will input data to the exchange via the exchange network into the exchange represented at (502). The market maker will post its best offer on the exchange (504). This information is transmitted in real-time to the broker (506). The market maker also has the ability to match, open and verify its account in real-time (508). The exchange will post the market maker's bid (504). At this point the exchange will verify if the market maker's account has the ability to cover the trade based on the minimum amount previously set by the exchange. This is so because the money comes off of the market maker's account upon updating of the account (526). The exchange will take the order for the trade from the trader (512). The exchange will update the broker's account by taking the deposit for the order and placing it into the interest bearing trust account (528). At (508) the exchange will match the market maker's bid and trader's order and open the position for both the market maker and the trader. Then the exchange will update (526) the market maker's account by taking the deposit for the position and placing it into the interest bearing trust account. After the maturity day, represented by line (530) the exchange will conduct a batch process of all trades including:

Close all open positions that are matured on that day (518);

Settle the broker's position(s) and update the account as described in Table 1 (520);

Settle the market maker's position(s) and update the account as described in table 1 (522);

Send the message to both the market maker and the broker.

Trading Short

Referring to FIG. 4, the exchange will transmit the trader's position and the market maker's position to the virtual trading floor. Routines within the virtual trading floor will determine whether the trader's order is for a long position or a short position (300). If the trader's order is for a short position (302) the virtual trading floor will determine whether or not the trader's order is at the market price set by the market maker (304). If the order is at market price then the order record is removed from the trading board (306) and a new short position is created for the trader (308). The virtual trading floor then instructs (310) the server to transmit the total required funds from the market maker's account to the exchange deposit account. Once the trader's position has been opened and accepted on the virtual trading floor, the server will transmit the next order (312) to the virtual trading floor.

Still referring to FIG. 4, if the order placed by the trader is a short position (302) and is not at the market price (304) a determination is made whether the market maker's short offer is greater than, or equal to, the trader's short bid (314). If it is, then the trader's short offer is accepted and the order record is taken off of the trading board (306) and the total necessary funds are transferred from the market maker's account to the exchange deposit account (308). If the market maker's short offer is less than the trader's short offer (310) then the offer is ignored and the next order on the board is processed.

Trading Long

Still referring to FIG. 4, if the trader is placing an order for a long position (318), a determination is made if the position is to be opened at the market price set by the market maker (320). If so, the offer is accepted (322) and the order is taken off the trading board (324). A new long position is created for the trader (326). The total required amount of money to cover the order is transferred from the market maker's account to the exchange deposit account (328). Then the next order on the board is processed (312).

If the long position is not to be opened at market price (330), a determination is made if the market maker's long offer is less than the trader's long bid (332). If so, the bid is accepted (334) and the record is taken off of the trading board (324). A new long position is created for the trader (326) and the required amount of funds to cover the order is transferred from the market maker's account to the exchange deposit account (328).

If the market maker's long offer is greater than the trader's long bid, then the offer is ignored (336) and the next order is processed (312).

Closing the Position

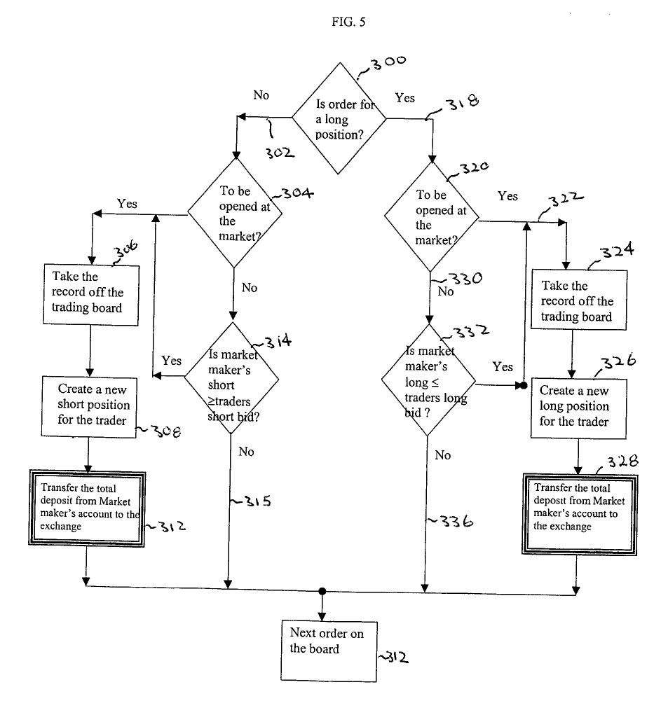

Referring to FIG. 5, once the trader's long and short positions have been opened on the virtual trading floor, the virtual trading floor will close the position either upon the request of the trader or upon the expiry of the derivative (400). The virtual trading floor will execute a routine to close the position (402). The payoff will be calculated according to the algorithm previously described herein (404). The appropriate transfer of funds will take place from the exchange deposit account to either the market maker's account or the trader's account (406). Once the position is closed and the payout completed the virtual trading floor will address the next open position and seek a match for it (408). If the position is not to be closed then the virtual trading floor will continue to review open positions until an open position can be closed and a payoff calculated. The difference between the opening and the closing values multiplied by the dollar-per-unit-value, to a maximum of an amount equal to deposit, represents the total amount to be paid from one party to another, depending on the type of the position whether it is long or short.

### EXAMPLE

To get a better understanding of the dynamics of the proposed exchange, consider the following trade example of a derivative whose underlying commodity is some given stock index that is initially at 1962 points. These steps are also presented in Table 1. Assume a DUV of $0.05 and a deposit of $10.00 per derivative, and currently, the market maker has posted the opening values for both the long and the short positions. As previously numerated, the trade takes the following steps:

1. Trader places an order for a contract at the market. The exchange withdraws $10.00 from both the market maker and the trader's account and initiates the position.

2. At a volatile market, the spot moves up dramatically and the trader closes the position when the spot value of the index is 2183 points.

3. The exchange calculates the payoff by subtracting the difference between the opening and the closing points, which is 2183-1974=209 points. Since the payoff exceeds $10.00, the exchange releases the trader's $10.00 deposit and transfers the market maker's deposit, ignoring the excessive 9×$0.05=$0.45, to the trader's account.

Note that the numerical values and the type of the underlying commodities are not part of the derivative's specification. They should remain as such since they may change from one underlying commodity to another.

As explained before, one other aspect of the proposed derivative is its marketability. That is, this derivative should provide a unique feature for which a trader would be willing to trade such derivative. For example, why should a trader trade this derivative when options provide a fixed maximum loss and an unbounded gain?

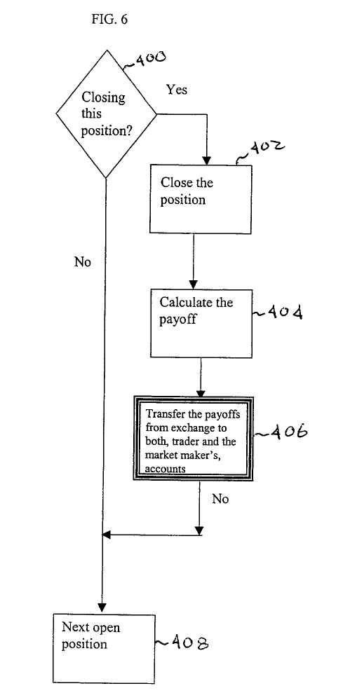

Referring to FIG. 6, the graph represents a comparison between the payoffs of the long futures contract; call option and the proposed derivative all with the same delivery month. It is commonly known that futures break-even point happens when the spot value reaches the value at which the contract was initiated. However, this is not the case for options. Because of the option premium, the break-even for the call option happens when the spot moves up greatly. Crudely speaking, the trader purchases the option in loss while he/she purchases the future contract at break-even. Therefore, in terms of the marketability of the derivatives, traders who are interested in the fixed maximum loss feature would be inclined to trade options with the penalty of initiating the position in loss. On the other hand, those who are interested in initiating the position at break-even would trade futures contract with the penalty of taking the risk of unbounded loss. By considering the payoff specification provided above and FIG. 6 one can see the feature that none of the other two derivatives provide: initiating the position at break-even with the feature of fixed maximum loss and the penalty of fixed maximum gain. Therefore, those who are interested in break-even advantage of the futures and the fixed maximum loss feature of the options would be willing to trade the proposed derivative.

Although the description above contains many specifications, these should not be construed as limiting the scope of the invention but as merely providing illustrations of some of the presently preferred embodiments of this invention. Thus the scope of the invention should be determined by the appended claims and their legal equivalents rather than by the examples given.

TABLE 1

| | | | | Accounts | | |
|---|---|---|---|---|---|---|
| | Open | | Close | (Held at the exchange) | | |
| | Long | Short | Spot | Exchange | Trader | Market maker |
| Market maker places bids for long | 1974 | 1950 | 1962 | $0.00 | $10.00 | $10.00 |
| and short positions in units of points | | | | | | |
| 1-Traders opens a long position | 1974 | | | $20.00 | $0.00 | $0.00 |
| 3-Trader closes the long position | | | 2183 | $20.00 | $0.00 | $0.00 |
| 4-Account is settled by the | | | | $0.00 | $20.00 | $0.00 |
| exchange | | | | | | |
| A numerical illustration of a trade is presented. The position is opened at either short or long by the choice of the trader and the bid of the market maker. Finally the position is closed at the spot. Before any trade taking place, the market maker and the trader cover the total possible losses by depositing the amount in the trustee account controlled by the exchange. In this example, the bullish trader wishes to open the account at the market. The exchange accordingly withdraws the | | | | | | |
| # total possible losses from both parties and holds the amount during the life of the position until its settlement. Once the position is closed at the spot, the exchange clears the accounts. In this example, the market maker has incurred the maximum loss of $10.00. | | | | | | |

What is claimed is:

1. A financial derivative exchange with guaranteed settlement comprising:
a. an electronic trading forum wherein derivatives are actively traded between market makers and investors;
b. means for investors to open and close positions in the electronic trading forum;
c. means for market makers to open and close positions in the electronic trading forum;
d. means for guaranteed settlement of positions thereby reducing the risk of default of the investor or market maker; and,
e. means for inputting market information into the electronic trading forum so that the values of underlying securities are accurate.

2. A method for trading financial derivatives over an exchange having guaranteed settlement comprising:
a. providing an electronic trading forum wherein derivatives are actively traded between market makers and investors;
b. providing means for investors to open and close positions in the electronic trading forum;
c. providing means for market makers to open and close positions in the electronic trading forum;
d. providing means for guaranteed settlement of positions thereby reducing the risk of default of the investor or market maker; and,
e. providing means for inputting market information into the electronic trading forum so that the values of the underlying securities and commodities are accurately reflected in the value of the derivatives.

3. The exchange as claimed in claim 1 wherein the electronic trading forum is a computer suitably programmed to execute derivative trading and remotely accessible by investors and market makers.

4. The exchange as claimed in claim 3 wherein a server is operably connected to the computer for receiving instructions from investors and market makers and relaying them to the computer and for transmitting trading confirmations from the computer to the investor and market maker.

5. The exchange as claimed in claim 4 wherein the server further stores data files containing relevant information with respect to the accounts of the investor and market maker.

6. The exchange as claimed in claim 5 wherein the investor has access to the server through a remote terminal whereby instructions to open and close positions can be relayed through the server to the computer and further whereby the investor's account information and market prices can be displayed.

7. The exchange as claimed in claim 6 wherein the investor can access the server remotely through the Internet.

8. The exchange as claimed in claim 6 wherein the investor can access the server remotely through a wireless device adapted to send and receive trading instructions.

9. The exchange as claimed in claim 5 wherein the market maker has access to the server through a remote terminal whereby instructions to open and close positions can be relayed through the server to the computer and further wherein the trading board, spot values and account information can be displayed.

10. The exchange as claimed in claim 9 wherein the market maker can access the server remotely through the Internet.

11. The exchange as claimed in claim 9 wherein the investor can access the server remotely through a wireless device adapted to send and receive trading instructions.

12. The method as claimed in claim 2 wherein means for an investor to open and close a position is a remote computer terminal linked to the exchange.

13. The method as claimed in claim 12 wherein the means for a market trader to open and close a position is a remote computer terminal linked to the exchange.

14. The exchange as claimed in claim 1 wherein means for guaranteed settlement of positions comprises:
a. an investor's electronic account containing investment funds accessible by the computer;
b. a market-marker's electronic account containing investment funds accessible by the computer;
c. an electronic exchange desposit account to which funds sufficient to cover a position is automatically transferred from the investor's account and the market maker's account when their respective positions are opened and from which funds are dispensed to the investor and market maker when the position is closed and the payout routine is executed; and,
d. means for determining payout of a position.

15. The guaranteed settlement means of claim 14 further comprising a server routine whereby the server is able to verify the identify of the investor and confirm sufficient funds exist in the investor's account to permit the a position to be opened.

16. The guaranteed settlement means of claim 15 wherein the server routine comprises an investor registration routine, and investor log-in routine, a challenge-response routine, and, an investor account verification routine.

17. The guaranteed settlement means of claim 16 wherein the investor registration routine comprises:
a. investor accessing the exchange server through a remote terminal;
b. investor indicating a desire to register with the exchange;
c. exchange server requesting registration information from the investor comprising:
i. personal identification data; and,
ii. financial information;
d. investor executing a contract agreeing to terms and conditions of exchange use;
e. server issuing registered investor with a password to be used;

18. The guaranteed settlement means of claim 17 wherein the log-in routine comprises:
a. the investor accessing the exchange server through a remote terminal;
b. the exchange server demanding the investor's identification data;
c. the investor provides the exchange server with identification data; and,
d. the exchange server confirms identity of registered investor.

19. The guaranteed settlement means of claim 18 wherein the response-challenge routine occurs after the exchange server confirms the identity of the registered user and comprises:
a. the exchange server issuing a challenge to the investor by demanding the registered pass word;
b. the registered investor providing the registered password to the exchange server;
c. the exchange server verifying the correct password; and,
d. the exchange server permits the investor access to the derivative exchange.

20. The guaranteed settlement means of claim 19 wherein the investor account verification routine is executed by the server after every trade request by the investor and comprises:
a. accepting the investor's request to open a trading position;
b. calculating the amount of funds necessary to settle the trading position;
c. verifying that sufficient funds are available in the investor's electronic trading account;
d. if sufficient funds are available, transferring the funds from the investor's electronic investment account to the exchange deposit account;
e. notify the investor of the transfer of funds;
f. update the trading board to reflect the investor's position;
g. display the trading board to the investor.

21. The guaranteed settlement means of claim 20 wherein there are insufficient funds in the investor's account to cover the position further comprising:
a. the server notifying the investor that there are insufficient funds in the account; and,
b. rejecting the investor's order.

22. The exchange as claimed in claim 1 wherein means for inputting market information into the electronic trading forum comprises data links to a plurality of commodity, financial and stock markets for receiving relevant information and adjusting the price of the derivative accordingly.

23. In a financial derivative exchange with guaranteed settlement comprising an electronic trading forum wherein derivatives are actively traded between market makers and investors; means for investors to open and close positions in the electronic trading forum; means for market makers to open and close positions in the electronic trading forum; means for guaranteed settlement of positions thereby reducing the risk of default of the investor or market maker; and, means for inputting market information into the electronic trading forum so that the values of underlying securities are accurate a method for creating a long position comprising:
a. the investor inputting the required data into the exchange server indicative of a long position;
b. the exchange server confirms that the trading order is for a long position;
c. the exchange server determines if the investor's bid price is at the market price;
d. the exchange server transmits the required funds from the investor's account to the exchange deposit account;
e. if the investor's bid price is at the market price the server transmits the order to the exchange for execution;
f. the exchange confirms execution of the order to the server;
g. the server confirms execution of the order to the investor;
h. the exchange server takes the record off of the trading board; and,
i. the server creates a new long position for the trader.

24. The method as claimed in claim 23 wherein the derivative is not to be purchased at market price, further comprising:
a. determining if the market maker's long offer is less than the trader's long bid for the derivative;
b. if the market marker's offer is less than the investor's bid then the server transmits the order to the exchange for execution;
c. the exchange server transmits the required funds from the investor's account to the exchange deposit account
d. the exchange confirms execution of the order to the server;
e. the server confirms execution of the order to the investor;
f. the exchange server takes the record off of the trading board; and,
g. the server creates a new long position for the trader.

25. The method as claimed in claim 24 wherein the market maker's long offer is greater than the investor's long bid comprising rejection of the order and notification of the investor of order rejection.

26. In a financial derivative exchange with guaranteed settlement comprising an electronic trading forum wherein derivatives are actively traded between market makers and investors; means for investors to open and close positions in the electronic trading forum; means for market makers to open and close positions in the electronic trading forum; means for guaranteed settlement of positions thereby reducing the risk of default of the investor or market maker; and, means for inputting market information into the electronic trading forum so that the values of underlying securities are accurate a method for creating a short position comprising:
a. the investor inputting the required data into the exchange server indicative of a short position;
b. the exchange server confirms that the trading order is for a short position;
c. the exchange server determines if the investor's bid price is at the market price;
d. the exchange server transmits the required funds from the investor's account to the exchange deposit account;
e. if the investor's bid price is at the market price the server transmits the order to the exchange for execution;
f. the exchange confirms execution of the order to the server;
g. the server confirms execution of the order to the investor;
h. the exchange server takes the record off of the trading board; and,
i. the server creates a new short position for the trader.

27. The method as claimed in claim 26 wherein the derivative is not to be purchased at market price, further comprising:
a. determining if the market maker's short offer is less than the trader's short bid for the derivative;
b. if the market marker's offer is less than the investor's bid then the server transmits the order to the exchange for execution;
c. the exchange server transmits the required funds from the investor's account to the exchange deposit account
d. the exchange confirms execution of the order to the server;
e. the server confirms execution of the order to the investor;
f. the exchange server takes the record off of the trading board; and,
g. the server creates a new short position for the trader.

28. The method as claimed in claim 27 wherein the market maker's short offer is greater than the investor's short bid comprising rejection of the order and notification of the investor of order rejection.

29. In a financial derivative exchange with guaranteed settlement comprising an electronic trading forum wherein derivatives are actively traded between market makers and investors; means for investors to open and close positions in the electronic trading forum; means for market makers to open and close positions in the electronic trading forum; means for guaranteed settlement of positions thereby reducing the risk of default of the investor or market maker; and, means for inputting market information into the electronic trading forum so that the values of underlying securities are accurate a method of closing a position comprising:
a. the investor indicates to the exchange server the desire to close a trading position;
b. the server relays the instructions to the exchange;
c. the exchange executes a payoff routine to determine the amount of funds due to the market maker or the investor;
d. the exchange transfers the required funds from the exchange deposit account to the investor's and market maker's accounts as required.
